(19) United States
(12) Patent Application Publication
(10) Pub. No.: US 2015/0181909 A1
(43) Pub. Date: Jul. 2, 2015

(54) METHOD FOR IMPROVING FEED EFFICIENCY AND INCREASING GROWTH RATES IN ANIMALS

(71) Applicant: Algal Scientific Corporation, Plymouth, MI (US)

(72) Inventors: Robert B. Levine, Ann Arbor, MI (US); Geoffrey P. Horst, Grosse Pointe Farms, MI (US)

(21) Appl. No.: 14/209,231

(22) Filed: Mar. 13, 2014

Related U.S. Application Data
(60) Provisional application No. 61/920,951, filed on Dec. 26, 2013.

(51) Int. Cl. A23K 1/00

(52) U.S. Cl. CPC A23K 1/008

(57) ABSTRACT

An animal feed composition includes algae meal and a feed component. The algae meal is present in an amount less than about 1000 g/MT by weight relative to a total weight of the animal feed composition. The animal feed composition may be administered to an animal for improving feed efficiency and increasing growth rate of the animal.

### CROSS-REFERENCE TO RELATED APPLICATIONS

This application claims the benefit of U.S. Provisional Application No. 61/920,951, filed on Dec. 26, 2013. The entire disclosure of the above application is hereby incorporated herein by reference.

### FIELD

The present disclosure relates to animal feed additives and, more particularly, to animal feed additives that improve feed efficiency and increase animal growth rates.

### BACKGROUND

Animal production at commercial facilities is a highly competitive enterprise where feed costs and facility throughput are typically the most important economic drivers.

To help reduce costs, producers want to keep feed efficiency high. One commonly used measure of feed efficiency is called the feed conversion ratio (FCR), which is equivalent to the pounds of feed consumed per pound of animal processed. The FCR can also be adjusted for mortality and culls, in which case it is defined as the pounds of feed consumed per pound of animal processed and culled. A more efficient operation has lower FCR values.

Another way to reduce costs is to increase facility throughput by increasing animal growth rates, so that individual animals achieve target market weights more quickly. The growth rate is typically measured in pounds per day and a producer wants to have as high a growth rate as possible.

Various strategies have been used to date to improve feed efficiency and increase animal growth rates. These can include the use of various natural and synthetic additives to the animal's feed or water, changes to the growth environment (e.g. temperature, lighting, bedding, etc.) and other means.

Any strategy employed to improve performance of animals must be economic for producers, typically delivering more than three times the return on investment. Very few products exist on the market today that can help producers economically improve performance. In addition, some products currently used, such as antibiotics, are problematic for several reasons and face regulations that limit their use.

There is a continuing need for a feed additive that improves feed efficiency and increases animal growth rates. Desirably, the feed additive may be used in an animal feed composition that allows individual animals consuming the animal feed composition to achieve target market weights more quickly.

### SUMMARY

In concordance with the instant disclosure, a feed additive that improves feed efficiency and increases animal growth rates, and which may be used in an animal feed composition that allows individual animals consuming the animal feed composition to achieve target market weights more quickly, is surprisingly discovered.

The present disclosure includes a method to improve feed efficiency and growth rates in animals by including very low doses (0.01 to 1 kg/metric ton of feed or 10 to 1000 g/MT of feed or 0.001 to 0.1 wt. %) of Euglena algae meal in the animal's dry feed. We have found that when this small amount of Euglena algae meal is added to an animal's diet, it has a surprising effect: the animal uses its feed more efficiently and grows faster. This result was surprising and unexpected, as the Euglena algae meal does not provide any meaningful addition of usable calories to the diet at these inclusion rates. By discovering that Euglena algae meal has this effect only when used at low doses, the present disclosure provides a means for producers to improve animal performance while achieving greater than a three times return on investment.

Furthermore, it has been surprisingly found that the performance-enhancing effect is not apparent at higher doses of Euglena algae meal. The optimum inclusion level of Euglena algae meal in an animal's diet may vary slightly depending on the species, its age, and its growth conditions, but the overall use of Euglena algae meal at very low levels is a distinguishing characteristic of the present disclosure. For example, in pen-house poultry studies, it has been discovered that feeding Euglena algae meal at 750 g/MT of feed does not improve feed efficiency and growth rates in male broilers, but feeding Euglena algae meal at 125 g/MT leads to significant improvements.

The nutritive value of Euglena algae meal (e.g., protein digestibility and amino acid composition) has been described by Kitaoka, S. and K. Hosotani, 1997, Agricultural Chemistry 51, 477-482. The use of Euglena algae meal at about 15-25 wt. % of the total diet for rats to substitute for other protein sources (e.g. casein) has been described by Hosotani, K. & S. Tikaoka, 1997, Agricultural Chemistry 51, 483-488. These studies revealed that Euglena meal is a source of readily digestible protein, which can be used in place of casein with no statistically significant differences in rodent body weight during a 10 day feeding study. These Japanese studies are similar to other reports in which various types of microalgae (e.g. Spirulina, Chlorella) have been grown, harvested, dried, and included in animal diets as a source of protein. In contrast to these known uses of algae meal, however, the present disclosure uses Euglena algae meal at low doses (about 100 times less than the cited examples), and as a growth promoting additive instead of a protein replacement product.

In one embodiment, an animal feed composition includes a feed component and algae meal. The algae meal is present in an amount less than about 1000 g/MT by weight relative to the total weight of the animal feed composition. The animal feed composition having the low concentration of algae meal may be administered or fed to an animal for improving feed efficiency and increasing growth rate of the animal.

In an exemplary embodiment, the algae meal is produced by heterotrophically growing Euglena sp. in sterile fermenters with a carbon source, dewatering the biomass, drying the biomass, grinding the biomass to reduce its particle size, and adding the dried powder to a feed or feed pre-mix.

In another embodiment, the Euglena algae meal is produced by heterotrophically growing Euglena sp. in sterile fermenters with a carbon source, dewatering the biomass, adding additional beneficial ingredients (e.g., trace metals like zinc), drying the biomass, grinding the biomass to reduce its particle size, and adding the dried powder to a feed or feed pre-mix. Optionally, the Euglena algae meal is produced as described above but dried with a spray dryer (instead of a drum dryer or other type of dryer that creates larger flakes), so that it does not require additional grinding after the drying step.

In a further embodiment, the dry algae meal may be produced as described above and then processed to remove unwanted components; for example, by way of sonication, bead milling, or other means of mechanical disruption, or by contact with various chemicals (e.g., acids, bases, solvents, etc.) to dissolve or otherwise remove unwanted fractions of the dry algae meal prior to use in the feed.

In a further embodiment, the Euglena algae meal is produced by heterotrophically growing Euglena sp. in sterile fermenters with a carbon source, dewatering the biomass, and adding the wet biomass paste to the feed (either before or after additional processing like pelleting) or feeding area directly (e.g. trough, bucket, or pond in the case of aquatic animals). The wet paste may optionally be processed at conditions suitable to pasteurize the material or somehow otherwise increase its self-life (e.g., packaging in retort pouches and processing by heating). The wet algae meal may optionally by processed to remove unwanted components; for example, by way of sonication, bead milling, or other means of mechanical disruption, or by contact with various chemicals (e.g., acids, bases, solvents, etc.) to dissolve or otherwise remove unwanted fractions of the wet algae meal prior to use in the feed. The wet paste may optionally be combined with other beneficial ingredients prior to use, such as trace metals like zinc, at any point during the production process.

In yet another embodiment, the Euglena algae meal is produced by heterotrophically growing Euglena sp. in sterile fermenters with a carbon source, dewatering the biomass, processing the biomass to remove unwanted components, drying the separate biomass fractions (two or more), optionally grinding each biomass fraction to reduce its particle size, and adding the dried powder(s) to a feed or feed pre-mix. The processed biomass may also be dried with a spray dryer (instead of a drum dryer or other type of dryer that creates larger flakes) so it does not require additional grinding after the drying step.

### DETAILED DESCRIPTION

The following detailed description and appended drawings describe and illustrate various embodiments of the disclosure. The description and drawings serve to enable one skilled in the art to make and use the disclosure, and are not intended to limit the scope of the disclosure in any manner. In respect of the methods disclosed, the order of the steps presented is exemplary in nature, and thus, is not necessary or critical unless otherwise disclosed.

The present disclosure describes an animal feed composition for improving feed efficiency and increasing growth rate of an animal, and more particularly a non-human animal. The animal feed composition includes a feed component and algae meal. The feed component may be any known constituent having nutritive value to the animal. As nonlimiting examples, the feed component may include at least one of dry rolled corn, alfalfa hay, dehulled soybean meal, vitamin/mineral premix, corn ground, whole cottonseed, cottonseed hulls, cottonseed meal, and fish meal. Other suitable constituents for the feed component may also be selected by one of ordinary skill in the art.

In certain embodiments, the algae meal is present in the animal feed composition in an amount less than about 1000 g/MT by weight relative to a total weight of the animal feed composition. For example, the algae meal may be present in an amount less than about 750 g/MT, particularly in an amount of less than about 500 g/MT, more particularly in an amount less than about 250 g/MT, and most particularly in an amount less than about 125 g/MT, by weight relative to the total weight of the animal feed composition. In a most particular embodiment, the algae meal is present in an amount between about 10 g/MT and about 125 g/MT by weight relative to the total weight of the animal feed composition. A skilled artisan may select suitably low concentrations, consistent with the teachings of the present disclosure, as desired.

The algae meal of the present disclosure may be provided by a biomass having unbranched beta-(1,3)-glucan. Unbranched beta-(1,3)-glucan can also be referred to as linear beta-(1,3)-glucan. The source of unbranched beta-(1,3)-glucan can be a non-toxic, non-pathogenic algae or protist of the genus Euglena, for example. The unbranched beta-(1,3)-glucan may be in the form of paramylon that is stored in rod-like bodies or granules throughout the cytoplasm of the Euglena. Advantageously, the Euglena may be grown heterotrophically in order to optimize the paramylon content of the Euglena biomass used to form the algae meal.

It should be appreciated that that the algae meal may be provided in either dry- or wet-form. Where provided in a dry form, the algae meal may be in the form of a dried powder. The dried powder may be ground to a desired particle size, for example, of less than about 1000 microns. In a particular example, the particle size may be about 150 microns to about 500 microns. Other suitable particle sizes may also be used, as desired. Where provided in a wet form, the algae meal may be in the form of a wet biomass paste with a water content of 40 to 90%. The dried powder or wet biomass past may be admixed with the feed component, to substantially evenly distribute the algae meal throughout the animal feed composition. It should be understood that other suitable methods for combining the algae meal with the feed component may also be employed.

The animal feed composition may further have at least one additional additive. The additive may be selected by a skilled artisan to enhance the nutritive value of the animal feed composition. For example, the additive may include at least one of a vitamin, a mineral, an essential fat/oil, and other nutritional and energy sources. In an illustrative embodiment, the additive may include zinc, for example, in the form of zinc sulfate, with which the algae meal may be complexed. Other types of additives may also be selected by one of ordinary skill in the art, as desired.

The present disclosure further describes a method of improving feed efficiency and increasing growth rate of the animal. The method includes the step of administering or feeding to the animal the animal feed composition as described hereinabove.

The animal feed composition of the present disclosure may be produced by admixing the feed component and the algae meal. In an exemplary embodiment, the algae meal is Euglena that has been heterotrophically grown in a sterile fermenter with a carbon source to form a biomass. Where a dry form of the algae meal is desired, the biomass of Euglena is then dewatered, optionally processed to remove unwanted components, and dried.

In one example, the dewatering may be performed by centrifuging the biomass, for example. The dewatering step is configured to remove a major portion of water or moisture present in the biomass following its removal from the fermenter. Other suitable means for dewatering the biomass may also be used, as desired.

The step of processing the biomass to remove the unwanted components may include at least one of mechanical disruption and chemical disruption. As nonlimiting examples, the mechanical disruption can include sonication, bead milling, high pressure homogenization, or other mechanical separation means. As further examples, the chemical disruption can include contacting the biomass with various chemicals (e.g., acids, bases, solvents, etc.), which dissolve or otherwise facilitate the removal of the unwanted fractions of the biomass. Other suitable means for removing the unwanted components from the biomass may also be employed within the scope of the disclosure.

In another example, the step of drying the biomass includes at least one or more of spray drying, drum drying, belt drying, or tray drying the dewatered biomass. The drying step is configured to remove a substantial portion of any moisture remaining in the biomass following the initial dewatering step. The drum drying may be performed at temperatures suitable for driving off excess water, while militating against a significant degradation of the biomass. Where spray drying is used, it should be appreciated that a desired particle size may be formed, and a subsequent grinding or milling step may be unnecessary. Other suitable means for drying the biomass may be selected by a skilled artisan, as desired.

Once dried, the biomass may be further dried to a desired particle size. For example, the biomass may be ground to a particle size of about 150 micron using a disc mill. Other suitable means for grinding the biomass, and other suitable particle sizes, may be used by one of ordinary skill in the art.

Advantageously, the use of Euglena algae meal at only low doses has surprisingly been found to improve feed efficiency and increase growth rates in animals. The improvements in growth rate at only low doses is further unexpected, in that skilled artisans have heretofore expected low doses to simply modulate immune function and compete with the same energy reserves that are used for animal growth.

### EXAMPLES

A dose response performance trial was conducted at a commercial research facility (OK Farms, AR) to demonstrate the use of Euglena algae meal as a performance-enhancing feed additive. Euglena sp. was grown heterotrophically in sterile fermenters with dextrose as a carbon source, dewatered with a centrifuge, complexed with zinc (from zinc sulfate) by mixing under controlled conditions, and then dried, ground to about 150 micron particle size in a disc mill, and added to the feed. The Euglena algae meal plus zinc product is known as Algamune ZPC™, commercially available from Algal Scientific Corporation in Northville, Mich., and contains 10% Zn. At low doses of Euglena algae meal, this amount of zinc likely has little effect since the typical poultry diet already has about 100 ppm zinc and 125 g/MT of Algamune ZPC delivers another 12.5 ppm zinc. Therefore, it should be understood that the performance-enhancing effects of Algamune ZPC are due to components of the Euglena algae meal and not the small amount of zinc it contains.

Newly hatched male Ross×Ross 708 chicks were placed into 96 pens (22 birds/pen at 0.75 sq. ft. per bird) and fed three diets containing various amounts of Algamune ZPC (Table 1). There were eight treatment groups in total, each studied in 12 replicate pens, and body weight (BW) and feed conversion ratio (FCR) were calculated at feed changes on days 14, 29, and 49 (Table 2). Treatment 2, which received 125 g/MT Algamune ZPC for the full 49 days, demonstrated the largest improvement in performance relative to the control group (treatment 1): the growth rate was 3.4% faster and the mortality-adjusted feed conversion ratio was 1.9% lower. When this FCR was standardized to 7.5 lb. birds, this treatment group showed a 4.1% improvement relative to the control birds.

Treatments 6 and 7, which were step-down dose regimes, also showed substantial improvements relative to the control birds. In the case of treatment 6, the use of 500 g/MT Algamune ZPC in the starter diet and no subsequent exposure resulted in an overall 3.4% improvement in growth rate with a 0.5% mortality adjusted improvement in the FCR. For treatment 7, when 250 g/MT Algamune ZPC was used in the starter, 125 g/MT in the grower, and none in the finisher feed, overall growth rates were increased 2.0% and mortality adjusted FCR was improved 0.2% relative to the control. Mortality+cull rates among treatments ranged from 4.2 to 10.2%, with the highest mortality+culls losses occurring in the last 4 days of the trial (45-49 days). The mortality+cull rate was not significantly different between the control group and treatment 2 (125 g/MT dose).

TABLE 1
Doses during the production cycle for each treatment group.

| | Starter | Grower | |
|---|---|---|---|
| Treatment | Dose | Dose | Finisher |
| Group | (g/MT) | (g/MT) | Dose (g/MT) |
| 1 | 0 | 0 | 0 |
| 2 | 125 | 125 | 125 |
| 3 | 250 | 250 | 250 |
| 4 | 500 | 500 | 500 |
| 5 | 500 | 125 | 0 |
| 6 | 500 | 0 | 0 |
| 7 | 250 | 125 | 0 |
| 8 | 250 | 0 | 0 |

TABLE 2
Broiler performance results by treatments to 49 days of age

| | Treatment Group | | | | | | | |
|---|---|---|---|---|---|---|---|---|
| | 1 Control | 2 | 3 | 4 | 5 | 6 | 7 | 8 |
| Birds Placed | 264 | 264 | 264 | 264 | 264 | 264 | 264 | 264 |
| Birds Processed | 247 | 246 | 250 | 252 | 247 | 237 | 238 | 253 |
| Total Mortality + Culls (%) | 6.44 | 6.82 | 5.30 | 4.55 | 6.44 | 10.23 | 9.85 | 4.17 |
| Average Weight (lb) | 7.660 | 7.920 | 7.642 | 7.767 | 7.707 | 7.919 | 7.812 | 7.699 |
| Feed Conv Ratio (FCR)¹ | 1.877 | 1.844 | 1.851 | 1.853 | 1.859 | 1.919 | 1.870 | 1.854 |
| FCR (Mort-Adj)² | 1.816 | 1.781 | 1.821 | 1.816 | 1.826 | 1.807 | 1.811 | 1.829 |
| FCR (Adj. to 7.5 lb BW)³ | 1.850 | 1.774 | 1.828 | 1.809 | 1.825 | 1.849 | 1.818 | 1.820 |
| Growth Rate (lb/day) | 0.156 | 0.162 | 0.156 | 0.159 | 0.157 | 0.162 | 0.160 | 0.157 |
| European Poultry | 365.7 | 383.9 | 368.3 | 378.2 | 365.8 | 364.6 | 360.3 | 373.8 |
| Efficiency Factor | | | | | | | | |
| (EPEF)⁴ | | | | | | | | |

In TABLE 2, three different feed conversions were calculated:
¹Feed conversion ratio = lb feed/lb of live weight of surviving birds delivered to plant;
²Feed conversion mortality-adjusted = lb feed/lb surviving birds plus lb of dead and culls; and
³Feed conversion adjusted to a common body weight = adjustment to 7.5 lb body weight using 0.06 pounds = 0.01 point of feed conversion change.
A European Poultry Efficiency Factor was also calculated:
⁴European Poultry Efficiency Factor = (Live weight (kg) × Livability (%) × 100)/(Age (days) × Feed conversion ratio).

The example shown in TABLE 1 and TABLE 2 demonstrates that, at 125 g/MT of feed, Euglena algae meal significantly improves performance relative to animals that did not receive this additive in the feed composition.

While certain representative embodiments and details have been described for purposes of illustrating the invention, it will be apparent to those skilled in the art that various changes may be made without departing from the scope of the disclosure, which is further described in the following appended claims.

What is claimed is:

1. An animal feed composition for improving feed efficiency and increasing growth rate of an animal, comprising: a feed component and algae meal, the algae meal present in an amount less than about 1000 g/MT by weight relative to a total weight of the animal feed composition.

2. The animal feed composition of claim 1, wherein the algae meal includes Euglena having unbranched beta-(1,3)-glucan.

3. The animal feed composition of claim 2, wherein the Euglena is grown heterotrophically.

4. The animal feed composition of claim 1, wherein the algae meal is in the form of a dried powder.

5. The animal feed composition of claim 4, wherein the dried powder is admixed with the feed component, and substantially evenly distributed throughout the animal feed composition.

6. The animal feed composition of claim 5, wherein the animal feed component includes at least one of dry rolled corn, alfalfa hay, dehulled soybean meal, vitamin/mineral premix, corn ground, whole cottonseed, cottonseed hulls, cottonseed meal, and fish meal.

7. The animal feed composition of claim 1, wherein the algae meal has a particle size of less than about 1000 microns.

8. The animal feed composition of claim 1, wherein the algae meal is present in an amount less than about 750 g/MT by weight relative to the total weight of the animal feed composition.

9. The animal feed composition of claim 1, wherein the algae meal is present in an amount less than about 500 g/MT by weight relative to the total weight of the animal feed composition.

10. The animal feed composition of claim 1, wherein the algae meal is present in an amount less than about 250 g/MT by weight relative to the total weight of the animal feed composition.

11. The animal feed composition of claim 1, wherein the algae meal is present in an amount less than about 125 g/MT by weight relative to the total weight of the animal feed composition.

12. The animal feed composition of claim 1, wherein the algae meal is present in an amount between about 10 g/MT and about 125 g/MT by weight relative to the total weight of the animal feed composition.

13. The animal feed composition of claim 1, further comprising a zinc additive with which the algae meal is complexed.

14. A method of improving feed efficiency and increasing growth rate of an animal, the method comprising the step of:
administering to the animal an animal feed composition comprising a feed component and algae meal, the algae meal present in an amount less than about 1000 g/MT by weight relative to a total weight of the animal feed composition.

15. A method of producing an animal feed composition for improving feed efficiency and increasing growth rate of an animal, the method comprising the step of:
admixing a feed component and algae meal to form the animal feed composition, the algae meal present in an amount less than about 1000 g/MT by weight relative to a total weight of the animal feed composition.

16. The method of claim 15, wherein the algae meal is provided by the steps of:
heterotrophically growing Euglena in a sterile fermenter with a carbon source to form a biomass;
detwatering the biomass;
processing the biomass to remove an unwanted fraction; and
drying the biomass to form the algae meal.

17. The method of claim 16, further comprising the step of grinding the biomass following the step of drying the biomass to reduce particle size and form a dried powder.

18. The method of claim 16, wherein the step of processing the biomass to remove the unwanted components includes at least one of mechanical disruption and chemical disruption.

19. The method of claim 16, wherein the step of drying the biomass includes at least one of spray drying and drum drying the dewatered biomass.

20. The method of claim 15, wherein the algae meal is added in the form of a wet paste to the feed component.
